(19) United States
(12) Patent Application Publication
(10) Pub. No.: US 2002/0160338 A1
(43) Pub. Date: Oct. 31, 2002

(54) Compatibility calculator and matchmaking by horoscope

(76) Inventor: Vladimir Yirmeyahu, New York, NY (US)

Correspondence Address: NOBLE GRACE LLC, 826 COLUMBUS AVENUE, SUITE 2-G, NEW YORK, NY, 10025, US

(21) Appl. No.: 09/788,010

(22) Filed: Feb. 16, 2001

(51) Int. Cl. G09B 19/00

(52) U.S. Cl. 434/106

(57) ABSTRACT

A method and system of matchmaking based on people's combined astrological compatibility, which is calculated as a weighted average of people's compatibilities under different astrological teachings. The matchmaking is accomplished by constructing a table of combined compatibility and allowing people to search a provided database based on this combined compatibility. Each pair of combined astrological signs within the table is assigned a combined compatibility number depending on astrological compatibility of the people within this pair. The method and software program, are based on Western and Chinese combined, cross-referenced astrological compatibility charts.

### RELATED APPLICATIONS

None

1. Field of the Invention

The invention is generally related to the field of astrological matchmaking. More specifically, the present invention relates to the method of calculating a combined compatibility of two people based on the compatibility of their various astrological signs, wherein a relative weight is assigned for a particular astrological compatibility and the resulting combined compatibility is calculated as their weighted average.

2. Background Information

Astrologers believe that many events in people's lives depend on their birth dates or, more specifically, on location of various celestial bodies at the time of their birth. There are two major astrological schools Western, commonly known as Star (or Sun) system, and Chinese, commonly referred to as Animal system. There are also several less popular systems, for example, Celtic Astrology and Vedic Astrology, which can be classified as branches of Western and Chinese Astrological schools respectively.

In Western astrology, main characteristics of a person are believed to be predetermined by his/her Sun Sign, i.e., one of 12 constellations in which the Sun was located when the person was born. There are twelve Sun Signs in Western Astrology: Aries, Taurus, Gemini, Cancer, Leo, Virgo, Libra, Scorpio, Sagittarius, Capricorn, Aquarius, and Pisces. Former president Bill Clinton, for example, was born on August 19, when the Sun was in the constellation of Leo, consequently his Sun Sign is Leo. People born under sign of Leo are believed to be courageous, generous and responsible.

In Chinese astrology, every year is believed to be governed by one of twelve animals. This governing animal determines main character traits of a person born under this animal's sign. The twelve animals are Rat, Ox, Tiger, Rabbit, Dragon, Snake, Horse, Goat, Monkey, Rooster, Dog, and Pig. To continue the example of former president Bill Clinton, who was born in 1946, that year was the Year of the Dog according to Chinese Astrology. Consequently, his Animal Sign according to Chinese astrology is Dog, or as it is traditionally said, Mr. Clinton was born in The Year of Dog. People born in the Year of Dog are believed to be loyal, trustworthy, friendly, kind and unselfish.

Besides mentioned main astrological characteristics common for all people born under a particular Western or Chinese sign, both systems have other, less important characteristics, associated with a person. Similarly to the main astrological signs, these less important characteristics influence people's characters, behavior and their compatibility with others. For example, each sign in Western astrology is ruled by one or more of nine solar planets and each person, in addition to the main sign has a Moon sign and a rising sign, which is determined by calculating which planet was rising in the sky at the time of this person's birth. Similarly, Chinese astrology has elements (Wood, Water, Fire, Metal and Earth), aspects (Yin and Yang) and “hour animals” (determined by a person's hour of birth), which may also influence people's character and compatibility with others.

Followers of both astrological schools believe that, as part of influencing our lives, the above factors influence our ability to get along with each other. For example, a Cancer (a person, whose Sun sign is Cancer) would be a very good friend to a Taurus, and a Rooster would never be happy with a partner-Rooster. Presently available astrological teachings, however, do not describe combined astrological compatibility between different signs numerically. Instead, they typically indicate which character traits will interfere with the relationship and which character traits will help the relationship. The above described rising signs and other astrological elements and qualities are also believed to have an effect on a person's compatibility with others.

For a long time world astrologers were divided as followers of either the Western or the Chinese school. Therefore, a person was considered to be a representative of either 12 Western Sun Signs or 12 Chinese Animals, depending on the school a particular astrologer followed. Recently, however, leading astrologers of both schools started a movement towards blending the two systems. Now, it is more and more widely believed that every person is a representative of one of 144 (12×12) astrological combinations, each of these combinations being a person's sun sign (determined by his/her lunar month of birth) and animal sign (determined by his/her lunar year of birth). So, Mr. Clinton's astrological sign is considered to be not just a Leo, as Western astrologers would believe, or a Dog, as Chinese astrologers would believe, but a combination of these two, i.e., the Leo/Dog. Thus, another person born in the same lunar year of Dog but in a different month will be characterized by a different combined astrological sign. The above system will result in 12 combined signs for each animal year, thus resulting in 144 astrological combinations.

The first book advancing this combined astrological system was The New Astrology by Suzanne White (fully incorporated herein by reference), published in English in 1986. This breakthrough integration of the two astrological systems dramatically changed the approach to compatibility assessment and calculation of signs. Indeed, previously there were only 78 different combinations of two people in each astrology school. The number 78 is derived from the following formula (12+1)×12×0.5=78, where 12 is a number of astrological signs. This formula calculates the number of non-zero elements in an upper triangular square matrix of 12 rows and 12 columns. See Table I.

This basic formula eliminates repetitive pairs such as Taurus+Gemini and Gemini+Taurus, or Rooster+Rat and Rat+Rooster.

TABLE I
An upper triangular square matrix of 12 rows and 12 columns.

| | Aries | Taurus | Gemini | Cancer | Leo | Virgo | Libra | Scorpio | Sagittarius | Capricorn | Aquarius | Pisces |
|---|---|---|---|---|---|---|---|---|---|---|---|---|
| Aries | X | X | X | X | X | X | X | X | X | X | X | X |
| Taurus | | X | X | X | X | X | X | X | X | X | X | X |
| Gemini | | | X | X | X | X | X | X | X | X | X | X |
| Cancer | | | | X | X | X | X | X | X | X | X | X |
| Leo | | | | | X | X | X | X | X | X | X | X |
| Virgo | | | | | | X | X | X | X | X | X | X |
| Libra | | | | | | | X | X | X | X | X | X |
| Scorpio | | | | | | | | X | X | X | X | X |
| Sagittarius | | | | | | | | | X | X | X | X |
| Capricorn | | | | | | | | | | X | X | X |
| Aquarius | | | | | | | | | | | X | X |
| Pisces | | | | | | | | | | | | X |

When the two astrological systems are combined together, there are 144 (12 Western×12 Chinese) combined signs, that in turn creates 20,736 combinations, or 6,084 (78×78) ways to make a unique, non-repetitive pair. Each individual pair will have its own compatibility rating. By reducing these compatibility ratings to numeric or percentage terms and organizing them into a combined compatibility table, a new method of studying peoples' compatibility is created. In addition to studying the compatibility, this method may be used for matchmaking, i.e., finding astrologically compatible partners. Many matchmaking services focus only on traditional criteria, such as age, religion, build, hair color, etc. While these are very important factors in people's relationships, often people can't get along even if they satisfy each other's traditional, or stereotypical, criteria of an ideal match. Some matchmaking services include person's astrological sign (mostly Western) as one of this person's characteristics, but they do not allow people to search for each other based on their combined astrological signs. More importantly, none of the existing matchmaking systems calculates a combined astrological compatibility between partners or allows its database to be searched based on the combined compatibility criteria.

### SUMMARY OF THE INVENTION

It is an object of the present invention to provide a method and system for determining people's combined astrological compatibility.

It is another object of the present invention to provide a method and a searching tool allowing a user to search a database of possible partners based on a combined astrological compatibility rating.

It is a further object of the present invention to provide a method and system for determining people's combined astrological compatibility by constructing a table of such combined compatibility.

It is still a further object of the present invention to provided handheld devices, gaming appliances and other apparatuses that will allow people to search for partners by using the combined astrological compatibility.

Further objects and/or advantages of the invention will become apparent in conjunction with the disclosure herein.

To accomplish the above enumerated objects, the present invention provides a method and system of matchmaking based on people's combined astrological compatibility. The matchmaking is accomplished by constructing a table of combined compatibility and allowing people to search a provided database based on this combined compatibility. Each pair of combined astrological signs within the table is assigned a combined compatibility number depending on astrological compatibility of the people within this pair. Compatibility table of combined astrological signs, consisting of 144 rows and 144 columns, allow its user to determine how different combined signs are astrologically compatible.

### BRIEF DESCRIPTION OF THE DRAWINGS

A full understanding of the invention can be gained from the following description of the preferred embodiments when read in conjunction with the accompanying drawings in which:

FIG. 1 is a preferred embodiment of the home page interface of a website presented in accordance with the present invention;

FIG. 2 is a preferred embodiment of the sign calculator query interface in accordance with the present invention;

FIG. 3 is a preferred embodiment of the sign calculator results interface in accordance with the present invention;

FIG. 4 is a preferred embodiment of the registration interface in accordance with the present invention;

FIG. 5 is a preferred embodiment of the login interface in accordance with the present invention;

FIG. 6 is a preferred embodiment of the combined compatibility query interface in accordance with the present invention;

FIG. 7 is a preferred embodiment of the compatibility results interface in accordance with the present invention;

FIG. 8 is a preferred embodiment of the search query interface in accordance with the present invention;

FIG. 9 is a preferred embodiment of the search results interface in accordance with the present invention;

FIG. 10 is a flow diagram of the searching algorithm in accordance with the preferred embodiment of the present invention;

FIG. 11 is a flow diagram of the algorithm for calculating a combined astrological compatibility of two people, performed as part of the search algorithm shown in FIG. 10, in accordance with the preferred embodiment of the present invention; and

FIG. 12 is a flow diagram of the combined compatibility algorithm for calculating a combined astrological compatibility of two people whose data is entered into the system by the user.

### DETAILED DESCRIPTION OF THE PREFERRED EMBODIMENTS AND THE DRAWINGS

The following Detailed Description describes the invention in connection with the compatibility calculating software and astrological matchmaking already partially implemented at NOBLEGRACE.COM, the web site containing astrological compatibility and matchmaking materials and a database of people looking for a compatible partner. It is to be understood, however, that the presently disclosed and claimed method and system of matchmaking and determining astrological compatibility can be implemented as a stand alone application, or as an application on a handheld portable gaming device, or even without utilizing a computer, for example, as a flash cards system.

In the preferred embodiment of the present invention an Internet website is provided which allows people to calculate their combined astrological compatibility with their partners or, alternatively, to search a website's database for an astrologically compatible partner. This system preferably has a database management system. In the preferred embodiment, the Apache web server and MySQL database are used. The website may be accessed by using desktop computer, handheld computer, WebTV, wireless device or any other Internet appliance through a dial-up Internet Service Provider, DSL, company LAN, wireless connection, etc. The provided website utilizes a software tool, or calculator, which calculates the combined astrological compatibility between signs. The calculator software used in the preferred embodiment is the NobleGrace® Compatible By Horoscope Calculator available from NOBLEGRACE.COM.

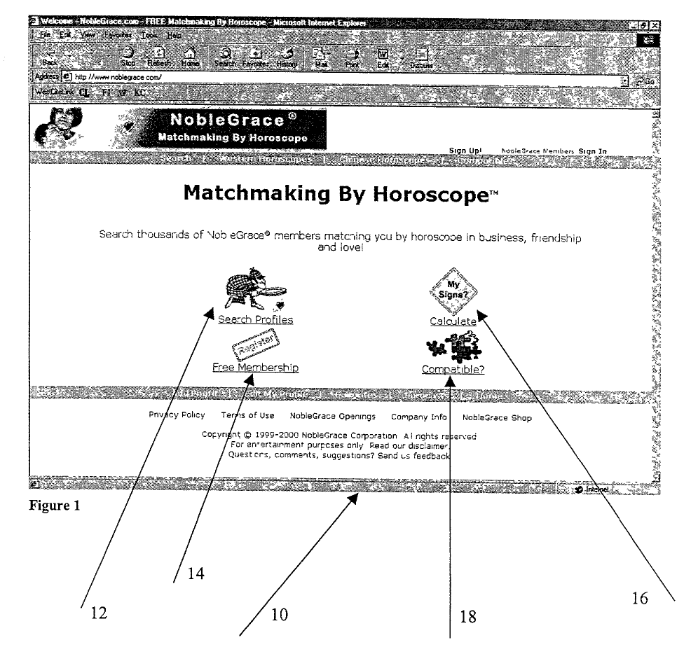

The preferred embodiment of the method and system for astrological matchmaking and determining astrological compatibility of partners based on their Western and Chinese astrological signs is illustrated in FIGS. 1-11. As shown in FIG. 1, each user starts the process by accessing a home page 10 of the provided website. The home page 10 preferably provides a search page link 12, allowing the user to access a search page, a registration link 14, allowing the user to access a registration page, a sign calculator link 16 and a compatibility calculator link 18.

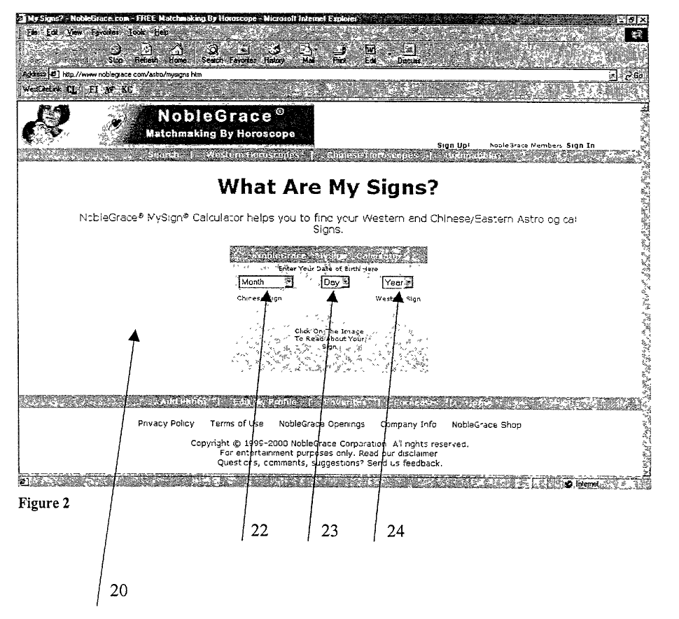

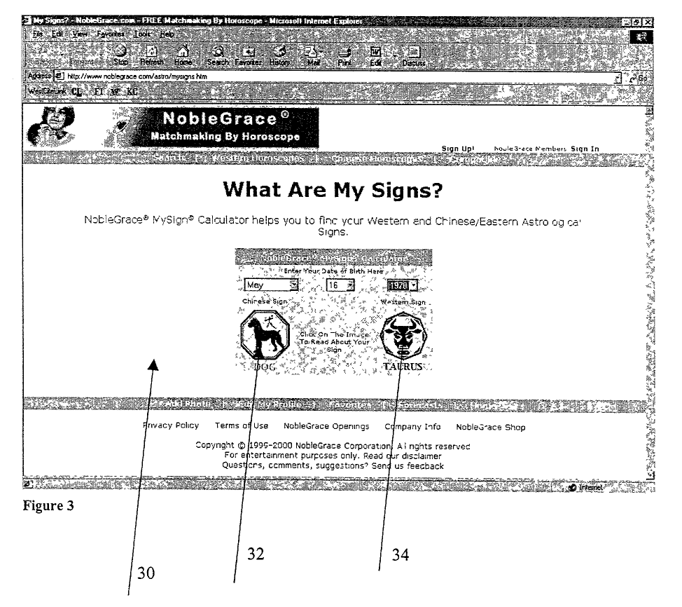

As shown in FIG. 2, by selecting the sign calculator link 16, the user will access the sign calculator query interface 20. In the preferred embodiment of the invention, the sign calculator interface allows the user to enter his/her month, day and year of birth in the provided fields 22-24, respectively. The user's day and month of birth will determine the Western, i.e., sun sign, and the user's year of birth (or more specifically, his/her lunar year of birth) will determine the Chinese, i.e., animal sign. After the user's signs are determined they are preferably displayed in a sign calculator results interface 30, shown in FIG. 3. Images of the Chinese and Western signs of the user will preferably appear in this interface. By selecting either the Chinese sign image 32 or the Western sign image 34, the user may access an individual sign interface (not shown). Each individual sign interface preferably contains a short description of qualities and personal character traits associated with a particular sign (both Chinese and Western).

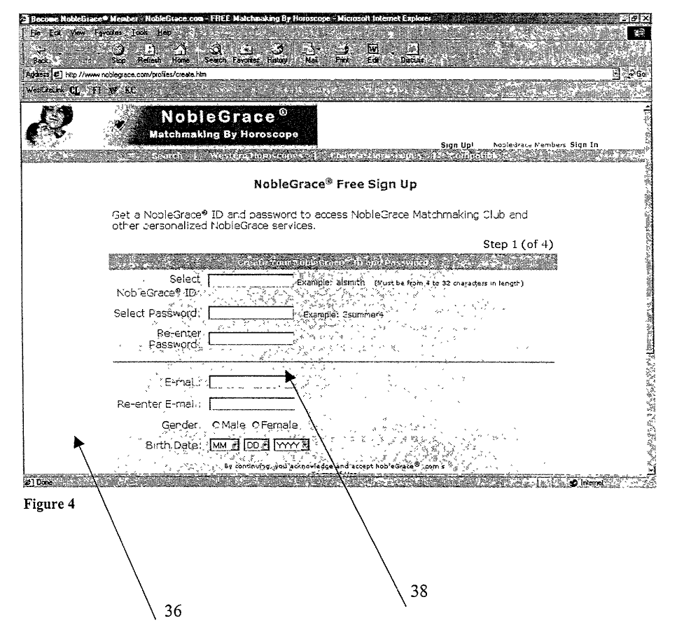

In accordance with the preferred embodiment of the present invention, users may be registered in a database associated with the website in order to be able to search the database or to determine their compatibility with their partners. The registration is preferably accomplished by accessing a registration interface 36, shown in FIG. 4, and filling out a questionnaire 38 by entering the required information into the appropriate fields. This information is then stored in the database. The registration interface may be accessed, for example, from the home page 10 by selecting the registration link 14. During the registration, a user will select his/her username and password that will be unique to this particular user and will identify him/her to the system. The system will preferably send an E-mail to the user after the registration with his/her username and password.

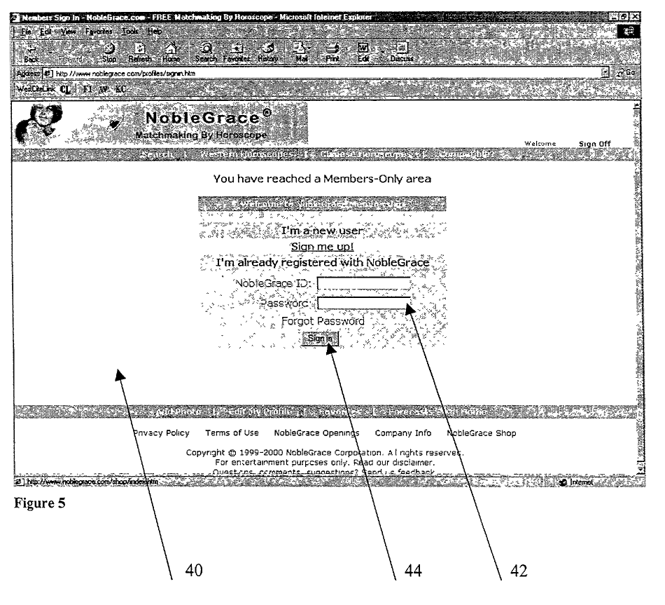

Alternatively, if a user is already registered, he or she may access the “members only” content by entering the username and password into the appropriate fields 42 and selecting the “Sign in” button 44 at the login interface 40, shown in FIG. 5.

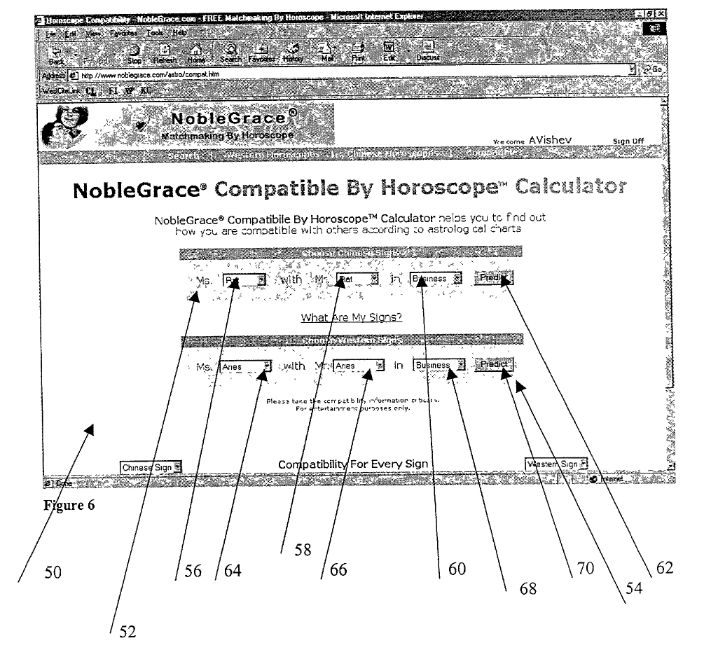

In accordance with the preferred embodiment of the present invention, a compatibility calculator is provided, where users may calculate their compatibility with their partners based on their astrological signs. As shown in FIG. 6, registered users may access the combined compatibility query interface 50. The interface 50 preferably has a Chinese signs query 52 and a Western signs query 54. In order to determine partners' Chinese compatibility, their signs should be selected from the scroll bars 56 and 58 containing all Chinese animal signs. One of the above scroll bars preferably corresponds to a female partner (scroll bar 56 in the embodiment shown in FIG. 6) and another scroll bar corresponds to a male partner (scroll bar 58 in the embodiment shown in FIG. 6). Of course, these scroll bars may be made gender neutral. The third scroll bar 60 within the Chinese signs query 52 allows the user to select the type of relationship between the partners, for example, love, friendship, business, etc. After the appropriate information is selected in the scroll bars 56, 58, and 60, the user may activate a Chinese compatibility algorithm by clicking on the “predict” button 62. Similarly to the above, the Western query 54 has two Sun signs scroll bars 64 and 66 and a third scroll bar 70 indicating the relationship between partners. By clicking on the “predict” button 70, the user may activate a Western compatibility algorithm. In order to determine a combined astrological compatibility of the partners, the user will select a combined compatibility link (not shown), which will activate a combined compatibility calculator algorithm.

The Chinese compatibility algorithm will compare the Chinese signs of the partners, selected in the scroll bars 56 and 58, to the Chinese compatibility table, shown herein as Table II. The Chinese compatibility table has 12 rows, corresponding to 12 Chinese animal signs, and 12 columns, also corresponding to the 12 animal signs. Each number, located in a cell at an intersection of one row and one column, indicates a numerical compatibility between the two Chinese animal signs (one from the row heading and another from the column heading). For example, the compatibility between two partners, one of which is a Rooster and another is a Tiger, equals to 1. In the preferred embodiment, “1” corresponds to the lowest possible compatibility, i.e. “highly incompatible,” and “8” corresponds to the highest possible compatibility, i.e., “highly compatible.” These numbers are determined based on various empirical studies and teachings of different astrologers. Of course, different numbers or various percentage terms may be selected to represent this compatibility.

TABLE II
Chinese Signs Compatibility Chart

| | Rat | Ox | Tiger | Rabbit | Dragon | Snake | Horse | Goat | Monkey | Rooster | Dog | Pig |
|---|---|---|---|---|---|---|---|---|---|---|---|---|
| Rat | 7 | 7 | 4 | 6 | 8 | 1 | 6 | 1 | 8 | 5 | 6 | 6 |
| Ox | 7 | 6 | 3 | 6 | 6 | 8 | 1 | 6 | 1 | 8 | 3 | 5 |
| Tiger | 4 | 3 | 6 | 4 | 6 | 3 | 8 | 1 | 6 | 1 | 8 | 7 |
| Rabbit | 6 | 6 | 4 | 7 | 6 | 6 | 3 | 8 | 1 | 6 | 1 | 8 |
| Dragon | 8 | 6 | 6 | 6 | 7 | 7 | 6 | 6 | 8 | 1 | 6 | 1 |
| Snake | 1 | 8 | 4 | 6 | 7 | 7 | 3 | 4 | 3 | 8 | 1 | 6 |
| Horse | 6 | 1 | 8 | 3 | 6 | 3 | 7 | 7 | 4 | 5 | 8 | 1 |
| Goat | 1 | 6 | 1 | 8 | 6 | 4 | 7 | 7 | 4 | 4 | 3 | 8 |
| Monkey | 8 | 1 | 6 | 1 | 8 | 3 | 4 | 4 | 7 | 4 | 6 | 6 |
| Rooster | 5 | 8 | 1 | 6 | 1 | 8 | 5 | 4 | 4 | 3 | 4 | 4 |
| Dog | 6 | 3 | 8 | 1 | 6 | 1 | 8 | 3 | 6 | 4 | 6 | 6 |
| Pig | 6 | 5 | 7 | 8 | 1 | 6 | 1 | 8 | 6 | 4 | 6 | 6 |

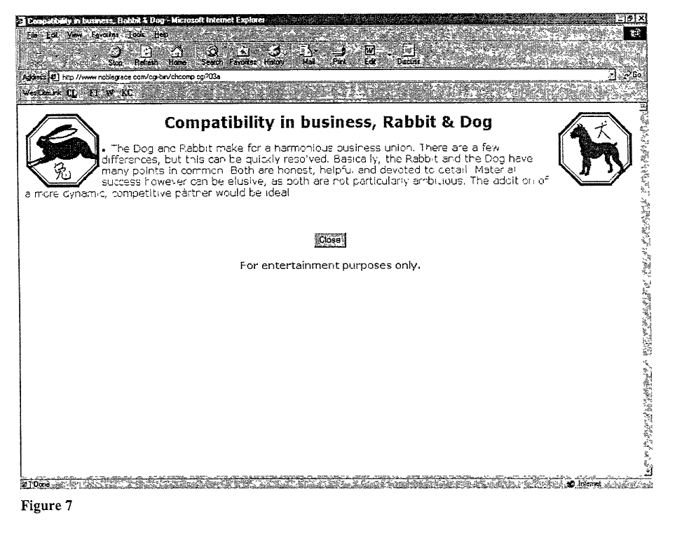

When the compatibility number is found, the algorithm will preferably display it to the user in the compatibility results interface. Additionally, a short description may accompany the displayed number, as shown for example in FIG. 7 (the description is shown without a compatibility number).

Similarly to the above described Chinese compatibility algorithm, the Western compatibility algorithm will compare the Sun signs of the partners, selected in the scroll bars 64 and 66, to the Western compatibility table, shown herein as Table III.

TABLE III
Western Signs Compatibility Chart

| | Aries | Taurus | Gemini | Cancer | Leo | Virgo | Libra | Scorpio | Sagittarius | Capricorn | Aquarius | Pisces |
|---|---|---|---|---|---|---|---|---|---|---|---|---|
| Aries | 7 | 7 | 4 | 6 | 8 | 6 | 1 | 4 | 8 | 5 | 6 | 6 |
| Taurus | 7 | 6 | 3 | 6 | 6 | 8 | 5 | 1 | 4 | 8 | 3 | 5 |
| Gemini | 4 | 3 | 6 | 4 | 6 | 3 | 8 | 4 | 1 | 5 | 8 | 7 |
| Cancer | 6 | 6 | 4 | 7 | 6 | 6 | 3 | 8 | 5 | 1 | 7 | 8 |
| Leo | 8 | 6 | 6 | 6 | 7 | 7 | 6 | 6 | 8 | 7 | 1 | 6 |
| | 6 | 8 | 4 | 6 | 7 | 7 | 3 | 4 | 3 | 8 | 6 | 1 |
| Libra | 1 | 5 | 8 | 3 | 6 | 3 | 7 | 7 | 4 | 5 | 8 | 6 |
| Scorpio | 4 | 1 | 4 | 8 | 6 | 4 | 7 | 7 | 4 | 4 | 3 | 8 |
| Sagittarius | 8 | 4 | 1 | 5 | 8 | 3 | 4 | 4 | 7 | 4 | 6 | 6 |
| Capricorn | 5 | 8 | 5 | 1 | 7 | 8 | 5 | 4 | 4 | 3 | 4 | 4 |
| Aguarius | 6 | 3 | 8 | 7 | 1 | 6 | 8 | 3 | 6 | 4 | 6 | 6 |
| Pisces | 6 | 5 | 7 | 8 | 6 | 1 | 6 | 8 | 6 | 4 | 6 | 6 |

The Western compatibility table has 12 rows and 12 columns, corresponding to 12 Sun signs. Similarly to the Chinese compatibility table, each number, located in a cell at an intersection of one row and one column, indicates a numerical compatibility between the two Sun signs (one from the row heading and another from the column heading). For example, the compatibility between two partners, one of which is a Scorpio and another is a Taurus, equals to 1. Again, “1” corresponds to the lowest possible compatibility, i.e. “highly incompatible,” and “8” corresponds to the highest possible compatibility, i.e., “highly compatible.” The compatibility number and a short description of the compatibility between partners may then be displayed by the algorithm to the user in a separate interface (not shown).

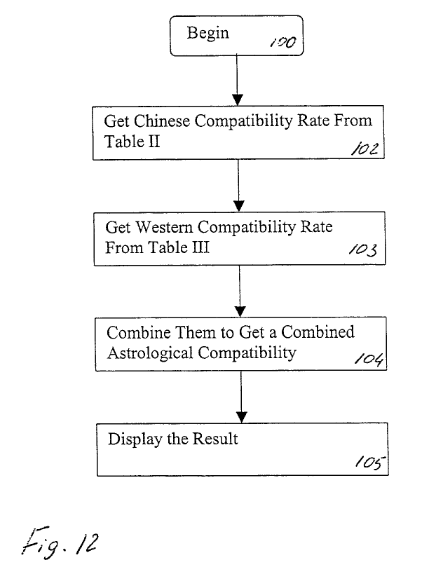

A combined astrological compatibility calculator is based on a combined compatibility algorithm. As shown in FIG. 12, this algorithm will start at block 100 and will first determine a couple's Chinese compatibility, utilizing the above described Chinese compatibility table, step 102. The algorithm will then proceed to determine the couple's Western compatibility, using the above described Western compatibility table, step 103. Couple's combined astrological compatibility may then be found as a weighted average of the Western and Chinese compatibilities, step 104, in accordance with the following formula:

### Equation 1.1

Combined Compatibility=Western Compatibility×Western Weight++Chinese Compatibility×Chinese Weight,

where

Western Compatibility—compatibility between signs according to Western Astrology;

Chinese Compatibility—compatibility between signs according to Chinese Astrology;

Western Weight—relative importance of Western Compatibility; and

Chinese Weight—relative importance of Chinese Compatibility.

In the preferred embodiment, the relative weight of the Chinese compatibility is preferably 75% and relative weight of the Western compatibility is preferably 25%. Thus, if compatibility between Taurus and Capricorn according to Western astrology is “8” or 100% in percentage terms, and compatibility between Ox and Horse according to Chinese astrology is “1” or 20% in percentage terms, then the combined astrological compatibility between Ox/Taurus and Horse/Capricorn is 40% (100%*0.25+20%*0.75=40%). The calculated combined astrological compatibility is then displayed to the user, step 105. In addition to the Western and Chinese compatibilities, the combined astrological compatibility may include people's rising signs and other astrological characteristics and non-astrological characteristics, by assigning their relative weights and adding them to the above formula.

Instead of entering the Chinese and Western astrological signs into the scroll bars 56, 58, 64, and 66, the user may enter birthdays of the partners and allow the algorithm to determine these signs, by comparing the entered birthdays to an internal calendar. The entered dates of birth may also be used by the algorithm to determine various other astrological characteristics, for example, people's rising signs. These calculations will preferably be performed on the background. The determined characteristics are preferably stored in a database as a person's astrological profile. For example, if a person provides a date of birth “Dec. 20, 1981”, some of the astrological data recorded will be “Rooster” (Chinese animal sign) and “Sagittarius” (Western Sun sign). It is to be understood that the above described algorithm may be used separately from the described website, as a standalone application, for example.

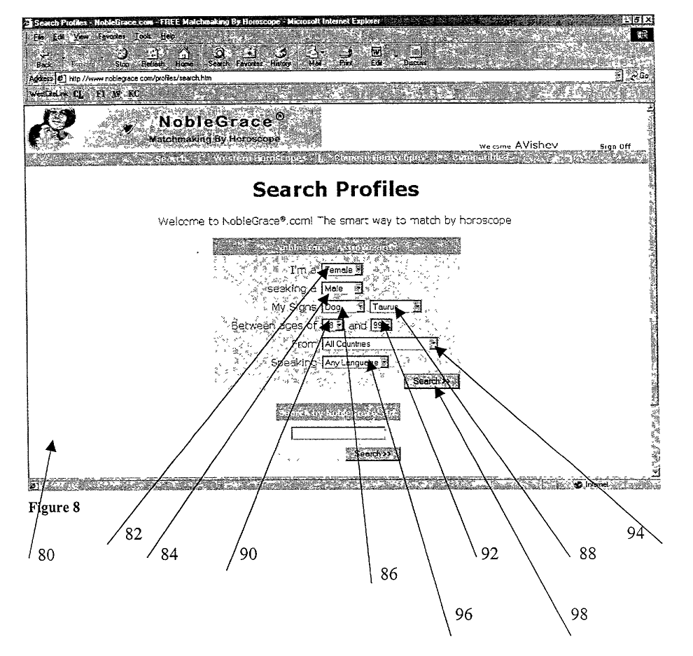

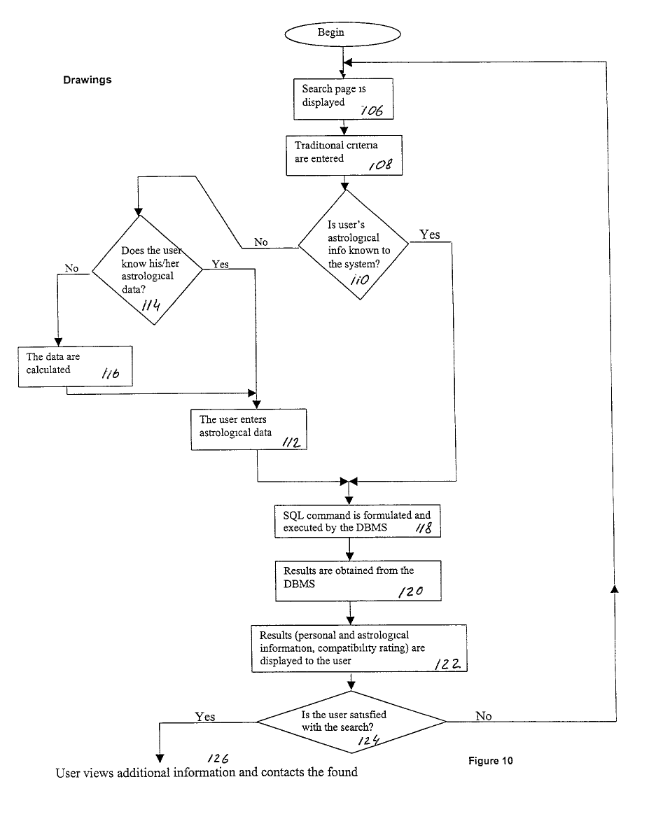

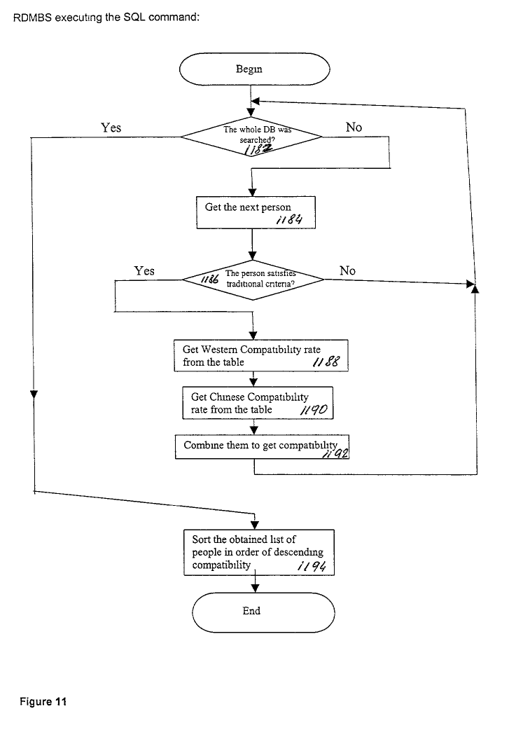

In another aspect of the preferred embodiment of the present invention, one registered user may search a provided database to find a compatible match. The preferred embodiment of the searching algorithm is shown in FIGS. 10 and 11. The user may access a search query interface 80, shown in FIG. 8, by selecting a “Search Profiles” link 12 on the home page 10. See step 106, FIG. 10. The search query interface preferably allows the user to enter a variety of traditional search criteria such as age, country, language, etc (step 108, FIG. 10). If the user knows his/her astrological signs (step 114, FIG. 10), the search interface also allows the user to enter the required astrological information, step 112. In the preferred embodiment shown in FIG. 8, eight scroll bars are provided, allowing the user to select his/her gender, scroll bar 82, gender of a potential partner, scroll bar 84, user's Chinese sign, scroll bar 86, user's Western sign, scroll bar 88, potential partner's age boundaries, scroll bars 90 and 92, user's country, scroll bar 94, and user's language, scroll bar 96. If the astrological information is already known to the system, step 110, (i.e., user is a registered member), this information will be extracted from the database and filled in automatically. Should the user not know his/her astrological information, there is an option to enter the user's date of birth and to calculate all relevant data, step 116, by following a link “My signs?” (not shown). After all information is entered, the user may activate the searching algorithm by clicking on the “Search” button 98.

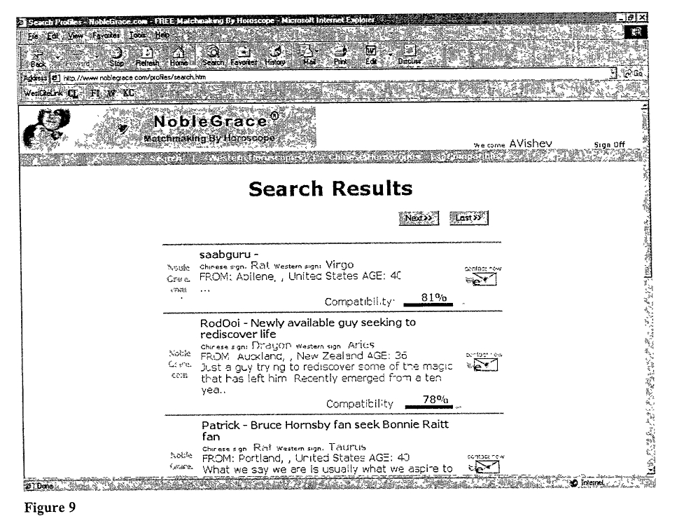

When the user clicks on the “search” button, the information is passed to the processing program. This program, based on these data, formulates a command (query) in SQL program language, step 118, and tells the database management system (in our case, MySQL) to execute it. Results are then obtained from the database management system, step 120, and displayed to the user, step 122, in a search results interface 200, shown in FIG. 9. If the user is satisfied with the obtained results, step 124, he/she may view additional information for each found match, step 126, or, alternatively, the user may perform the search again.

The execution step 118 is more particularly shown in FIG. 11. In order to execute the formulated query, the algorithm first determines whether the entire database was searched, step 1182. If the database was not search fully, the algorithm will select a new person within the database, step 1184. If the selected person satisfies the traditional criteria entered by the user, step 1186, the algorithm determines the Western compatibility rate, step 1188, and the Chinese compatibility rate, step 1190, and combines them in accordance with the above formula (see Equation 1.1) to determine the combined astrological compatibility, step 1192, between the selected person and the user. The process is then repeated for all people within the database. Specifically, the database management system selects all people that match traditional criteria (age, country, etc.); and for each selected person, it calculates the person's compatibility with the searching user, using compatibility tables for both Chinese & Western astrological data, and combining the two compatibility rates by using the above weighted-average formula. After the algorithm finishes searching through the database, it sorts the results in order of descending compatibility (that is, 100% compatible person is the first on the list), step 1194. Having sorted the information, the DBMS (Database Management System) stops executing the query and returns the result (selected people) to the processing program.

In an alternative preferred embodiment of the present invention, all Chinese/Western combined astrological compatibilities may be pre-calculated based on the provided individual compatibilities between Chinese animal signs, as shown in Table II, and provided individual compatibilities between Western Sun signs, as shown in Table III, in accordance with the formula given above. (see Equation 1.1) The resulting combined compatibilities may be entered into a 144×144 table of combined compatibilities, an excerpt of which is shown in Table IV below.

TABLE IV
Combined Astrological Compatibilities (Excerpt)

| | Rat/Aries | Rat/Taurus | Rat/Gemini | Rat/Cancer | Rat/Leo | Rat/Virgo |
|---|---|---|---|---|---|---|
| Rat/Aries | 7.00 | 7.00 | 6.25 | 6.75 | 7.25 | 5.50 |
| Rat/Taurus | 7.00 | 6.75 | 6.00 | 6.75 | 6.75 | 7.25 |
| Rat/Gemini | 6.25 | 6.00 | 6.75 | 6.25 | 6.75 | 6.00 |
| Rat/Cancer | 6.75 | 6.75 | 6.25 | 7.00 | 6.75 | 6.75 |
| Rat/Leo | 7.25 | 6.75 | 6.75 | 6.75 | 7.00 | 7.00 |
| Rat/Virgo | 5.50 | 7.25 | 6.25 | 6.75 | 7.00 | 7.00 |
| Rat/Libra | 6.75 | 5.50 | 7.25 | 6.00 | 6.75 | 6.00 |
| Rat/Scorpio | 5.50 | 6.75 | 5.50 | 7.25 | 6.75 | 6.25 |
| Rat/Sagittarius | 7.25 | 5.50 | 6.75 | 5.50 | 7.25 | 6.00 |
| Rat/Capricorn | 6.50 | 7.25 | 5.50 | 6.75 | 5.50 | 7.25 |
| Rat/Aquarius | 6.75 | 6.00 | 7.25 | 5.50 | 6.75 | 5.50 |
| Rat/Pisces | 6.75 | 6.50 | 7.00 | 7.25 | 5.50 | 6.75 |

Of course, the above combined astrological compatibilities may be expressed in percentage terms, as shown in Table V below.

TABLE V
Combined Astrological Compatibilities in Percentage Terms (Excerpt)

| | Rat/Aries | Rat/Taurus | Rat/Gemini | Rat/Cancer | Rat/Leo | Rat/Virgo |
|---|---|---|---|---|---|---|
| Rat/Aries | 87.50% | 87.50% | 78.12% | 84.38% | 90.62% | 68.75% |
| Rat/Taurus | 87.50% | 84.38% | 75.00% | 84.38% | 84.38% | 90.62% |
| Rat/Gemini | 78.12% | 75.00% | 84.38% | 78.12% | 84.38% | 75.00% |
| Rat/Cancer | 84.38% | 84.38% | 78.12% | 87.50% | 84.38% | 84.38% |
| Rat/Leo | 90.62% | 84.38% | 84.38% | 84.38% | 87.50% | 87.50% |
| Rat/Virgo | 68.75% | 90.62% | 78.12% | 84.38% | 87.50% | 87.50% |
| Rat/Libra | 84.38% | 68.75% | 90.62% | 75.00% | 84.38% | 75.00% |
| Rat/Scorpio | 68.75% | 84.38% | 68.75% | 90.62% | 84.38% | 78.12% |
| Rat/Sagittarius | 90.62% | 68.75% | 84.38% | 68.75% | 90.62% | 75.00% |
| Rat/Capricorn | 81.25% | 90.62% | 68.75% | 84.38% | 68.75% | 90.62% |
| Rat/Aquarius | 84.38% | 75.00% | 90.62% | 68.75% | 84.38% | 68.75% |

In this alternative embodiment, the searching algorithm will not perform calculation of the combined astrological compatibility, steps 1188, 1190 and 1192, described above, but will instead extract a combined compatibility rate from Table IV or Table V, and display this result to the user.

In the preferred embodiment of the present invention, the results of the above described search are presented to the user in the search results interface 200, shown in FIG. 9. Each displayed result preferably includes a username of the selected person, his/her Chinese and Western signs, contact information and the combined astrological compatibility between the user and the selected person. The system may be programmed to list all matches, with their compatibility rated from 1% to 100% in descending order, or, alternatively, to only display results having a combined compatibility rate higher than a certain threshold level. For example, the algorithm may display the matches whose combined compatibility with the user exceeds 50%. The user has the opportunity to view more information about the found match, contact him/her, or refine the search if a satisfactory match was not found.

The above described method of matchmaking by horoscope may also be realized as a TV show, where participants will be asked their dates of birth and given their combined compatibility with a selected partner. The show may also have an associated database, which may be searched to find an astrologically compatible match in accordance with the above described method. Alternatively, the matchmaking process may be organized as a cyber cafe, providing access to the Internet and giving users an opportunity to search for a compatible friend or partner among other people in the cafe or in an associated database.

The presently disclosed method of matchmaking may also be empirically tested by asking different couples if the combined compatibility rating obtained using the above method reflects their real relationship with their partners. When enough feedback is obtained the relative weights of the different elements within the combined compatibility calculator formula may be adjusted.

Having described this invention with regard to specific embodiments, it is to be understood that the description is not meant as a limitation since further variations or modifications may be apparent or may suggest themselves to those skilled in the art. For example, in addition to searching for a partner, the user may be able to search for lawyers, doctors, accountants, instructors and other individuals according to their astrological compatibility. It is intended that the present application cover such variations and modifications as fall within the scope of the appended claims.

I claim as follows:

1. A method of calculating people's combined astrological compatibility comprising the steps of:
a. constructing a table of combined compatibility, wherein each pair of combined astrological signs is assigned a combined compatibility number depending on astrological compatibility of said combined astrological signs within said each pair;
b. obtaining a first combined astrological sign;
c. obtaining a second combined astrological sign, said first combined astrological sign and said second combined astrological sign create a pair of combined astrological signs; and
d. selecting said combined compatibility number corresponding to a pair of said first combined astrological sign and said second combined astrological sign.

2. A method of calculating people's combined astrological compatibility according to claim 1, wherein said step of obtaining said first combined astrological sign further comprises the steps of determining a first Western astrological sign; determining a first Chinese astrological sign; and combining said first Western astrological sign with said first Chinese astrological sign, and wherein said step of obtaining said second combined astrological sign further comprises the steps of determining a second Western astrological sign; determining a second Chinese astrological sign; and combining said second Western astrological sign with said second Chinese astrological sign, said first Western astrological sign and said second Western astrological sign creating a pair of Western astrological signs; and said first Chinese astrological sign and said second Chinese astrological sign creating a pair of Chinese astrological signs.

3. A method of calculating people's combined astrological compatibility according to claim 2, wherein said step of constructing said table of combined compatibility further comprises the steps of:
a. assigning a first compatibility number to each said pair of Western astrological signs;
b. assigning a second compatibility number to each said pair of Chinese astrological signs;
c. giving predetermined mathematical weights to said first compatibility number and said second compatibility number;
d. determining said combined compatibility number for each pair of combined Western/Chinese astrological sign by calculating a weighted average of said first compatibility number and said second compatibility number; and
e. recording said combined compatibility number into said table of combined compatibility.

4. A method of calculating people's combined astrological compatibility according to claim 3, wherein said predetermined mathematical weights assigned to said first compatibility number is 25%.

5. A method of calculating people's combined astrological compatibility according to claim 3, wherein said predetermined mathematical weights assigned to said second compatibility number is 75%.

6. A method of matchmaking by using a combined astrological compatibility of two people comprising the steps of:
a. obtaining a first person's astrological data;
c. obtaining a second person's astrological data;
d. calculating a combined astrological compatibility of said first person and said second person based on said first person's astrological data and said second person's astrological data; and
e. displaying said calculated combined astrological compatibility.

7. A method of matchmaking according to claim 6 farther comprising the step of
a. providing a database of people, said database comprising astrological data for each of said people; and
b. selecting said second person from said database.

8. A method of matchmaking according to claim 6, wherein said first person's astrological data comprises a first person's combined astrological sign, said first person's combined astrological sign being said first person's Western sign and said first person's Chinese sign; and wherein said second person's astrological data comprises a second person's combined astrological sign, said second person's combined astrological sign being said second person's Western sign and said second person's Chinese sign.

9. A method of matchmaking according to claim 8, wherein said step of calculating a combined astrological compatibility of said first person and said second person further comprises calculating said combined astrological compatibility in accordance with a formula:
Combined Astrological Compatibility=Western Compatibility×Western Weight +Chinese Compatibility×Chinese Weight,
wherein, said Western Compatibility is a compatibility between said first person's and said second person's Western signs, said Chinese Compatibility is a compatibility between said first person's and said second person's Chinese signs, said Western Weight is a relative importance of said Western Compatibility, and said Chinese Weight is a relative importance of said Chinese Compatibility.

10. A method of matchmaking according to claim 9, wherein said Western weight is 25%.

11. A method of matchmaking according to claim 9, wherein said Chinese weight is 75%.

12. A method of matchmaking according to claim 8, wherein said first person's astrological data further comprises a first person's rising sign.

13. A method of matchmaking according to claim 8, wherein said second person's astrological data further comprises a second person's rising sign.

14. A system for calculating a combined astrological compatibility between people, comprising:
a. means for entering at least two combined astrological signs;
b. a table of combined astrological compatibility of all combined astrological signs, said table comprising a plurality of entries, each of said entries numerically representing a compatibility of two corresponding combined astrological signs;
c. means for extracting one of said entries in response to said entering of said at least two astrological signs; and
b. means for displaying said extracted entry to said user.

15. A system in accordance with claim 14, wherein said entries are calculated in accordance with a formula
Combined Compatibility=Western Compatibility×Western Weight +Chinese Compatibility×Chinese Weight,
wherein, said Western Compatibility is a compatibility according to Western Astrology, said Chinese Compatibility is a compatibility according to Chinese Astrology, said Western Weight is a relative importance of said Western Compatibility, and said Chinese Weight is a relative importance of said Chinese Compatibility.

16. A system according to claim 15, wherein said western weight is 25%.

17. A system according to claim 15, wherein said western weight is 75%.
